(19) United States
(12) Patent Application Publication
(10) Pub. No.: US 2011/0021726 A1
(43) Pub. Date: Jan. 27, 2011

(54) PREPOLYMERIZATION CATALYST COMPONENT AND PROCESS FOR PRODUCING THE SAME

(75) Inventors: Yasutoyo Kawashima, Ichihara (JP); Yoshinobu Nozue, Ichihara (JP); Naoko Ochi, Chiba (JP)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SUMITOMO CHEMICAL COMPANY, LIMITED, Tokyo (JP)

(21) Appl. No.: 12/933,327

(22) PCT Filed: Mar. 16, 2009
(86) PCT No.: PCT/JP2009/055563

§ 371 Date: Sep. 17, 2010

(30) Foreign Application Priority Data
Mar. 18, 2008 (JP) 2008-068995
Dec. 5, 2008 (JP) 2008-310768

(51) Int. Cl. C08F 4/52; B01J 31/22

(52) U.S. Cl. 526/114; 502/159; 526/159

(57) ABSTRACT

The purpose of the invention is to provide a process for producing a prepolymerization catalyst component which is homogeneous and does not a tendency that it adheres to a wall surface of a dryer and that the prepolymerization catalyst component are aggregated with each other. The process comprises the following steps (1) to (4):

step (1): heat-treating a solution containing a metallocene-based compound (B1), which is prepared by dissolving the metallocene-based compound (B1) shown below in a saturated hydrocarbon solvent, at 40° C. or above to obtain a heat-treated material (1);
step (2): heat-treating a mixture of the heat-treated material (1) and a metallocene-based compound (B2) shown below at 40° C. or above to obtain a heat-treated material (2);
step (3): subjecting the above heat-treated material (2) and a cocatalyst support (A) to a contact treatment to obtain a contact treatment product (3); and
step (4): subjecting the contact treatment product (3) and an organoaluminum compound (C) to a contact treatment to obtain a contact treatment product (4).

### TECHNICAL FIELD

The present invention relates to a process for producing a prepolymerization catalyst component, a prepolymerization catalyst component produced by this process, and a method for producing an olefin polymer using the prepolymerization catalyst component.

### BACKGROUND ART

For the polymerization of olefins, there is known a vapor phase polymerization method in which a solid-state catalyst and an olefin are supplied to a fluidized bed reactor for polymerizing the olefin in the fluidized bed to obtain a granular polymer. Since this method does not require a polymer precipitation step and a polymer separation step after the polymerization, it is possible with this method to simplify the production process and to reduce the production cost in comparison with a liquid phase polymerization method. As a component of the solid-state catalyst used in the vapor phase polymerization method, there is generally used a so-called prepolymerization catalyst component obtained by prepolymerizing an olefin in the presence of a solid catalyst component. For the production of such a prepolymerization catalyst component, a method is known in which ethylene and an α-olefin are subjected to slurry polymerization by using a solid catalyst component comprising a metallocene-based compound and an organoaluminoxy compound supported on a support. More specifically, Patent Document 1, for instance, discloses a method for obtaining a prepolymerization catalyst component which comprises carrying out prepolymerization of ethylene using a solid catalyst component obtained by heat treating silica and methylaluminoxane in toluene, adding dropwise thereto a toluene solution of two metallocene-based compounds, and further subjecting the mixed solution to a heat treatment.

### [Patent Document 1] JP-A-6-206923

### DISCLOSURE OF INVENTION

### Problem to be Solved by the Invention

The above-mentioned method of producing a prepolymerization catalyst component, however, would be attended by such problems as non-homogeneity of the produced prepolymerization catalyst component, adhesion thereof to the wall surface of the dryer, and aggregation of the granules of the produced component. Under these circumstances, the present invention is envisioned to solve the problems involved in producing a prepolymerization catalyst component by using two or more metallocene-based compounds, and to this end, the present invention provides a prepolymerization catalyst component which is homogeneous, hardly adheres to the wall surface of the dryer and also has little tendency in its granules to get aggregated with each other; a process for producing such a prepolymerization catalyst component; and a method for producing an olefin polymer by using this prepolymerization catalyst component.

### Means for Solving the Problem

Thus, the first aspect of the present invention is to provide a process for producing a prepolymerization catalyst component by carrying out a prepolymerization of an olefin in the presence of a contact treatment product (4) obtained by subjecting a cocatalyst support (A), a metallocene-based compound (B1), a metallocene-based compound (B2) and an organoaluminum compound (C) to a contact treatment, the process comprising the following steps (1) to (4):

step (1): heat-treating a solution containing a metallocene-based compound (B1), which is prepared by dissolving the metallocene-based compound (B1) shown below in a saturated hydrocarbon solvent, at 40° C. or above to obtain a heat-treated material (1);

step (2): heat-treating a mixture of the heat-treated material (1) and a metallocene-based compound (B2) shown below at 40° C. or above to obtain a heat-treated material (2);

step (3): subjecting the above heat-treated material (2) and a cocatalyst support (A) to a contact treatment to obtain a contact treatment product (3); and

step(4): subjecting the contact treatment product (3) and an organoaluminum compound (C) to a contact treatment to obtain a contact treatment product (4);

wherein the metallocene-based compound (B1) is a transition metal compound represented by the following formula [1] or its μ-oxo type transition metal compound dimer:

L¹ₐM¹X¹_{b} [1]

(wherein M¹ is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X¹ is a halogen atom; a is a number which satisfies the definition of 0<a≦8; and b is a number which satisfies the definition of 0<b≦8); and

the metallocene-based compound (B2) is a transition metal compound represented by the following formula [2] or its μ-oxo type transition metal compound dimer:

L¹ₐM¹X²_{b} [2]

(wherein M² is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X² is a hydrocarbon group (exclusive of the groups having a cyclopentadiene type anionic skeleton) or a hydrocarbonoxy group; a is a number which satisfies the definition of 0<a≦8; and b is a number which satisfies the definition of 0<b≦8).

The second aspect of the present invention is to provide a prepolymerization catalyst component produced from the above-described process.

The third aspect of the present invention is to provide a method for producing an olefin polymer which comprises carrying out polymerization of an olefin by using the above-described prepolymerization catalyst component.

### Advantages of the Invention

According to the present invention, there are provided a prepolymerization catalyst component produced by using two or more metallocene-based compounds, the produced catalyst component being homogeneous, scarcely adhering to the wall surface of the dryer, and having little tendency in its granules to get aggregated with each other; a process for producing such a prepolymerization catalyst component;

and a method for producing an olefin polymer using the above-described prepolymerization catalyst.

### EMBODIMENTS FOR CARRYING OUT THE INVENTION

The present invention is a process for producing a prepolymerization catalyst component by carrying out a prepolymerization of an olefin in the presence of a contact treatment product (4) obtained by subjecting a cocatalyst support (A), a metallocene-based compound (B1), a metallocene-based compound (B2) and an organoaluminum compound (C) to a contact treatment, the process comprising the following steps (1) to (4):

step (1): heat-treating a solution containing a metallocene-based compound (B1), which is prepared by dissolving the metallocene-based compound (B1) shown below in a saturated hydrocarbon solvent, at 40° C. or above to obtain a heat-treated material (1);
step (2): heat-treating a mixture of the heat-treated material (1) and a metallocene-based compound (B2) shown below at 40° C. or above to obtain a heat-treated material (2);
step (3): subjecting the above heat-treated material (2) and a cocatalyst support (A) to a contact treatment to obtain a contact treatment product (3); and
step(4): subjecting the contact treatment product (3) and an organoaluminum compound (C) to a contact treatment to obtain a contact treatment product (4).

Step (1) is a step in which a solution containing a metallocene-based compound (B1), prepared by dissolving a metallocene-based compound (B1) in a saturated hydrocarbon compound solvent, is subjected to a heat treatment at a temperature of 40° C. or above to obtain a heat treated material (1). This solution containing a metallocene-based compound (B1) can be prepared by, for instance, by a method in which a metallocene-based compound (B1) is introduced into a saturated hydrocarbon compound solvent. The metallocene-based compound is usually introduced in the form of a powder or a slurry of a saturated hydrocarbon compound solution. The ratio of the metallocene-based compound (B1) to the saturated hydrocarbon compound solvent in the metallocene-based compound-containing solution is usually 10 g/L or less as determined in terms of concentration of the metallocene-based compound (B1) in the saturated hydrocarbon compound solvent.

Step (2) is a step in which a mixture of the heat treated material (1) obtained in the step (1) and a metallocene-based compound (B2) is subjected to a heat treatment at a temperature of 40° C. or above to obtain a heat treated material (2). The mixture of the heat treated material (1) and a metallocene-based compound (B2) can be prepared by, for instance, a method in which a metallocene-based compound (B2) is incorporated into the heat treated material (1) obtained from the step (1). The metallocene-based compound (B2) is supplied into the heat treated material (1) usually in the form of a powder or a slurry of a saturated hydrocarbon compound solution. The heat treated material (1) and metallocene-based compound (B2) mixing ratio is adjusted such that the metallocene-based compound (B1)/metallocene-based compound (B2) molar ratio will be usually (B1)/(B2)<1.

The saturated hydrocarbon compound solvents usable in the present invention include, for instance, propane, normal butane, isobutene, normal heptane, isopentane, normal hexane, cyclohexane and heptane. These solvents may be used singly or as a combination of any two or more of them. Preferred of these solvents are the ones whose boiling point under normal pressure is 100° C. or below, more preferably 90° C. or below. Examples of such preferred solvents include propane, normal butane, isobutane, normal pentane, isopentane, normal hexane and cyclohexane. In these solvents, a saturated aliphatic hydrocarbon compound such as propane, normal butane and isobutene are more preferred.

In the heat treatments in the step (1) and the step (2), temperature of the solution containing a metallocene-based compound (B1) or the mixture of the heat treated material (1) and a metallocene-based compound (B2) is adjusted at 40° C. or above. This solution or mixture may be allowed to stand or may be stirred during the heat treatment. The temperature of the above solution or mixture is preferably adjusted at 45° C. or above, more preferably 50° C. or above, from the viewpoint of enhancement of homogeneity of the obtained prepolymerization catalyst or decrease of aggregates of the granules. The temperature is preferably not higher than 100° C., more preferably not higher than 80° C., from the viewpoint of enhancing catalytic activity. The time for the heat treatment is usually from 0.5 to 12 hours. It is preferably not shorter than 30 minutes, more preferably not shorter than one hour, for the reason of enhanced homogeneity of the obtained prepolymerization catalyst or decreased aggregates of the granules. Also, from the standpoint of safety of the catalytic activity, the heat treatment time is preferably not longer than 6 hours, more preferably not longer than 4 hours. The temperature and time for the heat treatment in the step (1) and those in the step (2) may be identical with or different from each other.

Step (3) is a step in which the heat treated material (2) obtained in the step (2) (viz. a solution comprising a saturated hydrocarbon compound solvent containing a metallocene-based compound (B1) and a metallocene-based compound (B2)) and a cocatalyst support (A) are subjected to a contact treatment to obtain a contact treatment product (3). In this contact treatment, the heat treated material (2) and a cocatalyst support (A) are simply brought into contact with each other. For this treatment, there is usually used a method in which a cocatalyst support (A) is introduced into the heat treated material (2) or a method in which both of the heat treated material (2) and the cocatalyst support (A) are introduced into a saturated hydrocarbon compound solvent. The cocatalyst support (A) is usually supplied in the form of a powder or a slurry of a saturated hydrocarbon compound solvent. The mixing ratio of the cocatalyst support (A) to the heat treated material (2) is usually adjusted so that the total amount of the metallocene-based compounds (B1) and (B2) contained in the heat treated material (2) will become usually 0.000001 to 0.001 mol, preferably 0.00001 to 0.001 mol, per gram of the cocatalyst support (A).

The transition metal compound (B2) to transition metal compound (B1) molar ratio ((B2)/(B1)) is in the range of from 1 to 300, preferably from 5 to 200, more preferably from 50 to 200.

The temperature for the contact treatment in the step (3) is preferably 70° C. or below, more preferably 60° C. or below, from the viewpoints of enhancement of homogeneity of the obtained prepolymerization catalyst and reduction of the aggregates of granules. From the viewpoint of control of fouling, the contact treatment temperature is preferably not lower than 10° C., more preferably not lower than 20° C. The time for the contact treatment is usually from 0.1 to 2 hours.

Step (4) is a step in which the contact treatment product (3) obtained in the step (3) and an organoaluminum compound (C) are subjected to a contact treatment to obtain a contact treatment product (4). This contact treatment can be effected by simply bringing the contact treatment product (3) and an organoaluminum compound (C) into contact with each other. For this treatment, there is usually used a method in which an organoaluminum compound (C) is introduced into the contact treatment product (3), or a method in which both of the contact treatment product (3) and an organoaluminum compound (C) are introduced into a saturated hydrocarbon compound solvent.

In the present invention, a prepolymerization catalyst component can be produced by introducing and prepolymerized an olefin in the presence of the contact treatment product (4) obtained in the step (4), or by starting prepolymerization almost simultaneously with the formation of the contact treatment product (4). The contact treatment product (4) is often a substance which is prone to decompose. Since the contact treatment producty (4) can be used for producing a prepolymerization catalyst component before this product (4) is decomposed, it is preferable to conduct the step (4) in the presence of an olefin. By carrying out the normal polymerization of an olefin by using the prepolymerization catalyst component obtained by any of the above-described methods, it is possible to conduct polymerization under a condition of high catalytic activity from the moment after start of the normal polymerization reaction.

In the present invention, all of the above-described steps (1), (2), (3) and (4) may be performed in a single prepolymerization reactor by supplying a saturated hydrocarbon compound solvent, a cocatalyst support (A), a metallocene-based compound (B1), another metallocene-based compound (B2) and an organoaluminum compound (C) successively into the reactor. It is also possible to conduct the steps (3) and (4) in a prepolymerization reactor by using the heat treated material (2) which had been prepared previously in a separate vessel. Further, step (4) may be carried out in a prepolymerization reactor by using the contact treatment product (3) prepared previously in a separate vessel.

Usually a slurry polymerization method is employed for the prepolymerization, which may be carried out according to any of the batchwise, semi-batchwise and continuous systems. Also, a chain transfer agent such as hydrogen may be added in carrying out the prepolymerization.

When slurry polymerization is employed for the prepolymerization, usually a saturated hydrocarbon compound is used as solvent, the examples thereof being propane, normal butane, isobutene, normal pentane, isopentane, normal hexane, cyclohexane and heptane. These solvents may be used singly or as a combination of any two or more of them. Such a saturated hydrocarbon compound is preferably one whose boiling point under normal pressure is 100° C. or below, more preferably 90° C. or below. Preferred examples of the saturated hydrocarbon compound solvents are propane, normal butane, isobutane, normal pentane, isopentane, normal hexane and cyclohexane. When the prepolymerization is carried out as slurry polymerization, the slurry concentration is adjusted so that the amount of the cocatalyst support (A) supplied will stay within the range of usually from 0.1 to 600 g, preferably from 0.5 to 300 g, per litre of the solvent.

In case of producing a prepolymerization catalyst component by introducing and prepolymerizing an olefin after obtaining a contact treatment product (4) in the step (4), the temperature applied for the contact treatment of the contact treatment product (3) and an organoaluminum compound (C) in the step (4) is preferably 70° C. or below, more preferably 60° C. or below on account of enhancement of homogeneity of the obtained prepolymerization catalyst component and reduction of the aggregates of granules. Also, from the viewpoint of activation of the olefin polymerization, the treating temperature is preferably not lower than 10° C., more preferably not lower than 20° C. The time for the contact treatment is usually from 0.01 to 0.5 hours.

The temperature applied when introducing and prepolymerizing an olefin in the presence of the contact treatment product (4) is usually from −20 to +100° C., preferably from 0 to 80° C. The polymerization temperature may be varied properly in the course of prepolymerization operation, but the temperature at which the prepolymerization is started is preferably set at 70° C. or below, more preferably 60° C. or below. The partial pressure of the olefin in the vapor phase section during the prepolymerization is usually from 0.001 to 2 MPa, preferably from 0.01 to 1 MPa. The prepolymerization time is usually from 2 minutes to 15 hours.

The temperature applied when producing a prepolymerization catalyst component by carrying out the step (4) in the presence of an olefin is preferably 70° C. or below, more preferably 60° C. or below, for the reason of enhancing homogeneity of the obtained prepolymerization catalyst component and minimizing aggregation of granules. From the viewpoint of maximized activation of olefin polymerization, the temperature for this operation is preferably not lower than 10° C., more preferably not lower than 20° C. After carrying out the contact treatment at an above-defined temperature for a period of usually from 0.01 to 0.5 hours, the prepolymerization operation is further continued at a temperature of usually from −20 to +100° C. to produce a polymerization catalysts component. The polymerization temperature may be varied properly during the prepolymerization operation, but preferably the temperature is set at 0 to 80° C. The prepolymerization is continued at the above-defined temperature for a period of from 2 minutes to 15 hours for obtaining a desired prepolymerization catalyst component. The partial pressure of the olefin in the vapor phase section during the prepolymerization operation is usually from 0.001 to 2 MPa, preferably from 0.01 to 1 MPa.

The olefins usable for the prepolymerization in the present invention include ethylene, propylene, 1-butene, 1-pentene, 1-hexene, 1-octene, 4-methyl-1-pentene, cyclopentene, cyclohexene and the like. These olefins may be used singly or in the form of a mixture of any two or more of them. Preferably ethylene alone or a combination of ethylene and an α-olefin is used. More preferably, ethylene alone or a combination of ethylene and at least one α-olefin selected from 1-butene, 1-hexene and 1-octene is used.

The content of the prepolymer in the prepolymerization catalyst component is usually from 0.01 to 1,000 g, preferably from 0.05 to 500 g, more preferably from 0.1 to 200 g, per gram of the cocatalyst support (A).

The molecular weight distribution (Mw/Mn) of the polymer formed by prepolymerization preferably falls within a range of from 3 to 20. For determining the molecular weight distribution (Mw/Mn), the polystyrene-reduced weight-average molecular weight (Mw) and number-average molecular weight (Mn) of the polymer were determined by GPC, and Mw was divided by Mn (Mw/Mn).

The cocatalyst support (A) comprises a granular support supporting a compound (such as an organoaluminoxy compound, boron compound, organozinc compound or the like) which ionizes a metallocene-based compound (B1) and another metallocene-based compound (B2) to form an ionic complex. The supports of this type are disclosed in JP-A-6-336502, JP-A-2003-171412, JP-A-2005-68170, etc. Preferred among these supports is one formed by supporting a boron compound or an organozinc compound on a granular support.

Exemplary of the boron compounds usable for the above purpose are tris(pentafluorophenyl)borane, triphenylcarbeniumtetrakis(pentafluorophenyl) borate, tri(n-butyl)ammoniumtetrakis(pentafluorophenyl) borate, and N,N-dimethylaniliniumtetrakis(pentafluorophenyl) borate. An example of the zinc compounds usable for the above purpose is a contact treatment product obtained by subjecting diethylzinc, fluorinated phenol and water to a contact treatment.

As the cocatalyst support (A), there can be used, for instance, a solid catalyst composition such as disclosed in JP-A-2003-171412, JP-A-2005-68170, etc., viz. a solid catalyst composition obtained by having the following component materials (a), (b), (c) and (d) catalytically contacted with each other:

(a): a compound represented by the formula: M²L²ₘ [3];
(b): a compound represented by the formula: R¹ₜ₋₁TH [4];
(c): a compound represented by the formula: R²ₜ₋₂TH₂ [5]; and

(d): a granular support.

(In the above formulae [3] to [5], M² represents an atom of a metal of Group 1, 2, 12, 14 or 15 in the periodic table; m represents a number corresponding to the valency of M²; L² represents a hydrogen atom, a halogen atom or a hydrocarbon group, and when there exist plural L², they may be identical or different from each other; R¹ represents an electron withdrawing group or a group containing an electron withdrawing group, and when there exist plural R¹, they may be identical or different from each other; R² represents a hydrocarbon group or a halogenated hydrocarbon group; T's represent independently an atom of a nonmetal of Group 15 or 16 of the periodic table; and t represents a number corresponding to the valency of T of the respective compounds.)

As the component (a), dimethylzinc, diethylzinc, dipropylzinc, di-n-butylzinc, diisobutylzinc and the like can be cited as possible examples, of which dimethylzinc and diethylzince are preferred.

As the component (b), fluorinated phenols such as pentafluorophenol, 3,5-difluorophenol, 3,4,5-trifluorophenol and 2,4,6-trifluorophenol can be named as candidate examples.

As the component (c), water, trifluoromethylamine, perfluorobutylamine, perfluorooctylamine, perfluoropentadecylamine, 2-fluoroaniline, 3-fluoroaniline, 4-fluoroaniline, 2,6-difluoroaniline, 3,5-difluoroaniline, 2,4,6-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline, and the like can be used. Water and pentafluoroaniline are preferred.

As the component (d), the porous materials are preferably used, which include inorganic oxides such as SiO₂, Al₂O₃, MgO, ZrO₂, TiO₂, B₂O₃, CaO, ZnO, BaO and ThO₂; clays and clay minerals such as smectite, montmorillonite, hectorite, laponite and saponite; and organic polymers such as polyethylene, polypropylene and styrene-divinylbenzene copolymer.

The weight-average molecular weight of the cocatalyst support (A) is usually from 10 to 100 μm, preferably from 20 to 80 μm, more preferably from 30 to 60 μm.

As the metallocene-based compound (B1), there can be used, for instance, the transition metal compounds represented by the following formula [1] and their μ-oxo type transition metal compound dimers:

L¹ₐM¹X¹_{b} [1]

(wherein M¹ is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X¹ is a halogen atom; a is a number which satisfies the definition of 0<a≦8; and b is a number which satisfies the definition of 0<b≦8).

As the metallocene-based compound (B2), there can be used the transition metal compounds represented by the following formula [2] and their μ-oxo type transition metal compound dimers:

L¹ₐM¹X²_{b} [2]

(wherein M¹ is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X² is a hydrocarbon group (exclusive of the groups having a cyclopentadiene type anionic skeleton) or a hydrocarbonoxy group; a is a number which satisfies the definition of 0<a≦8; and b is a number which satisfies the definition of 0<b≦8).

In the formulae [1] and [2], M¹ is a periodic table (IUPAC 1989) Group 3 to 11 or lanthanoid series transition metal atom. Examples of such a transition metal atom include scandium atom, yttrium atom, titanium atom, zirconium atom, hafnium atom, vanadium atom, niobium atom, tantalum atom, chromium atom, iron atom, ruthenium atom, cobalt atom, rhodium atom, nickel atom, palladium atom, samarium atom, and ytterbium atom. Preferred among these metal atoms are titanium atom, zirconium atom, hafnium atom, vanadium atom, chromium atom, iron atom, cobalt atom and nickel atom, with titanium atom, zirconium atom and hafnium atom being especially preferred, and zirconium atom the most preferred. M¹'s in the formula [1] and the formula [2] may represent a same atom or different atoms.

In the formulae [1] and [2], L¹'s are each a group having a cyclopentadiene type anionic skeleton, and L¹'s may be identical or different from each other. Also, L¹'s may be connected directly to each other or may be connected through the medium of a crosslinking group containing one or two or more of carbon atom, silicon atom, nitrogen atom, oxygen atom, sulfur atom and phosphorus atom.

As the groups having a cyclopentadiene type anionic skeleton, there can be cited η⁵-(substituted)cyclopentadieny groups, η⁵-(substituted)indenyl groups and η⁵-(substituted)fluorenyl groups as typical examples. To be more specific, they include η⁵-cyclopentadienyl group, η⁵-methylcyclopentadienyl group, η⁵-ethylcyclopentadienyl group, η⁵-n-butylcyclopentadienyl group, η⁵-tert-butylcyclopentadienyl group, η⁵-1,2-dimethylcyclopentadienyl group, η⁵-1,3-dimethylcyclopentadienyl group, η⁵-1-methyl-2-ethylcyclopentadienyl group, η⁵-1-methyl-3-ethylcyclopentadienyl group, η⁵-1-tert-butyl-2-methylcyclopentadienyl group, η⁵-1-tert-butyl-3-methylcyclopentadienyl group, η⁵-1-methyl-2-isopropylcyclopentadienyl group, η⁵-1-methyl-3-isopropylcyclopentadienyl group, η⁵-1-methyl-2-n-butylcyclopentadienyl group, η⁵-1-methyl-3-n-butylcyclopentadienyl group, η⁵-1,2,3-trimethylcyclopentadienyl group, η⁵-1,2,4-trimethylcyclopentadienyl group, η⁵-tetramethylcyclopentadienyl group, η⁵-pentamethylcyclopentadienyl group, η⁵-indenyl group, η⁵-4,5,6,7-tetrahydroindenyl group, η⁵-2-methylindenyl group, η⁵-3-methylindenyl group, η⁵-4-methylindenyl group, η⁵-5-methylindenyl group, η⁵-6-methylindenyl group, η⁵-7-methylindenyl group, η⁵-2-tert-butylindenyl group, η⁵-3-tert-butylindenyl group, η⁵-4-tert-butylindenyl group, η⁵-5-tert-butylindenyl group, η⁵-6-tert-butylindenyl group, η⁵-7-tert-butylindenyl group, η⁵-2,3-dimethylindenyl group, η⁵-4,7-dimethylindenyl group, η⁵-2,4,7-trimethylindenyl group, η⁵-2-methyl-4-isopropylindenyl group, η⁵-4,5-benzindenyl group, η⁵-2-methyl-4,5-benzindenyl group, η⁵-4-phenylindenyl group, η⁵-2-methyl-5-phenylindenyl group, η⁵-2-methyl-4-phenylindenyl group, η⁵-2-methyl-4-naphthylindenyl group, η⁵-fluorenyl group, η⁵-2,7-dimethylfluorenyl group, η⁵-2,7-di-tert-butylfluorenyl group, and their substituents. It is to be noted that in the description which follows, the prefix “η⁵-” in the designations of the transition metal compounds may be omitted.

The groups having a cyclopentadiene type anionic skeleton may be connected to each other either directly or through the medium of a crosslinking group containing one or two or more of carbon atom, silicon atom, nitrogen atom, oxygen atom, sulfur atom and phosphorus atom. Examples of such crosslinking groups include alkylene groups such as ethylene and propylene; substituted alkylene groups such as dimethylmethylene and diphenylmethylene; silylene groups and substituted silylene groups such as dimethylsilylene, diphenylsilylene and tetramethyldisilylene; and hetero atoms such as nitrogen atom, oxygen atom, sulfur atom and phosphorus atom.

Regarding the metallocene-based compounds (B1), X¹ in their representing formula [1] is a halogen atom such as, for instance, a fluorine atom, a chlorine atom, a bromine atom or an iodine atom. X¹ is preferably a chlorine atom because of easy availability of its complexes.

Regarding the metallocene-based compounds (B2), X² in their representing formula [2] is a hydrocarbon group (exclusive of the groups having a cyclopentadiene type anionic skeleton) or a hydrocarbonoxy group. The hydrocarbon groups referred to herein do not include the groups having a cyclopentadiene type anionic skeleton. Examples of the hydrocarbon groups represented by the formula [2] are alkyl, aralkyl, aryl and alkenyl. Examples of the hydrocarbonoxy groups are alkoxyl, aralkyloxy and aryloxy.

The alkyl groups in the hydrocarbon groups represented by X² in the formula [2] include methyl, ethyl, n-propyl, isopropyl, n-butyl, sec-butyl, tert-butyl, isobutyl, n-pentyl, neopentyl, amyl, n-hexyl, n-octyl, n-decyl, n-dodecyl, n-pentadecyl, and n-eicosyl groups. Any of these alkyl groups may be substituted with a halogen atom such as fluorine atom, chlorine atom, bromine atom or iodine atom. Examples of the alkyl groups substituted with a halogen atom include fluoromethyl group, trifluoromethyl group, chloromethyl group, trichloromethyl group, fluoroethyl group, pentafluoroethyl group, perfluoropropyl group, perfluorobutyl group, perfluorohexyl group, perfluorooctyl group, perchloropropyl group, perchlorobutyl group, and perbromopropyl group. Any of these alkyl groups may be partly substituted with an alkoxyl group such as methoxy and ethoxy, an aryloxy group such as phenoxy, or an aralkyloxy group such as benzyloxy.

The aralkyl groups include benzyl group, 2-methylphenyl)methyl group, (3-methylphenyl)methyl group, (4-methylphenyl)methyl group, (2,3-dimethylphenyl)methyl group, (2,4-dimethylphenyl)methyl group, (2,5-dimethylphenyl)methyl group, (2,6-dimethylphenyl)methyl group, (3,4-dimethylphenyl)methyl group, (3,5-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, (pentamethylphenyl)methyl group, (ethylphenyl)methyl group, (n-propylphenyl)methyl group, (isopropylphenyl)methyl group, (n-butylphenyl)methyl group, (sec-butylphenyl)methyl group, (tert-butylphenyl)methyl group, (n-pentylphenyl)methyl group, (neopentylphenyl)methyl group, (n-hexylphenyl)methyl group, (n-octylphenyl)methyl group, (n-decylphenyl)methyl group, (n-dodecylphenyl)methyl, naphthylmethyl group, and anthracenylmethyl group. Any of these alkyl groups may be partly substituted with a halogen atom such as fluorine atom, chlorine atom, bromine atom and iodine atom; an alkoxyl group such as methoxy and ethoxy; an aryloxy group such as phenoxy or an aralkyloxy group such as benzyloxy.

The aryl groups include phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, 2,3,4,5-tetramethylphenyl group, 2,3,4,6-tetramethylphenyl group, 2,3,5,6-tetramethylphenyl group, pentamethylphenyl group, ethylphenyl group, n-propylphenyl group, isopropylphenyl group, n-butylphenyl group, sec-butylphenyl group, tert-butylphenyl group, n-pentylphenyl group, neopentylphenyl group, n-hexylphenyl group, n-octylphenyl group, n-decylphenyl group, n-dodecylphenyl group, n-tetradecylphenyl group, naphthyl group, and anthracenyl group. Any of these aryl groups may be partly substituted with a halogen atom such as fluorine atom, chlorine atom, bromine atom and iodine atom; an alkoxyl group such as methoxy and ethoxy; an aryloxy group such as phenoxy or an aralkyloxy group such as benzyloxy.

The alkenyl groups include allyl, methallyl, crotyl, and 1,3-diphenyl-2-propenyl.

The alkoxyl groups include methoxy group, ethoxy group, n-propoxy group, isopropoxy group, n-butoxy group, sec-butoxy group, tert-butoxy group, n-pentoxy group, neopentoxy group, n-hexoxy group, n-octoxy group, n-dodesoxy group, n-pentadesoxy group, and icosoxy group. Any of these alkoxyl groups may be partly substituted with a halogen atom such as fluorine atom, chlorine atom, bromine atom and iodine atom; an alkoxyl group such as methoxy and ethoxy; an aryloxy group such as phenoxy or an aralkyloxy group such as benzyloxy.

The aralkyloxy groups include benzyloxy group, (2-methylphenyl)methoxy group, (3-methylphenyl)methoxy group, (4-methylphenyl)methoxy group, (2,3-dimethylphenyl)methoxy group, (2,4-dimethylphenyl)methoxy group, (2,5-dimethylphenyl)methoxy group, (2,6-dimethylphenyl)methoxy group, (3,4-dimethylphenyl)methoxy group, (3,5-dimethylphenyl)methoxy group, (2,3,4-trimethylphenyl)methoxy group, (2,3,5-trimethylphenyl)methoxy group, (2,3,6-trimethylphenyl)methoxy group, (2,4,5-trimethylphenyl)methoxy group, (2,4,6-trimethylphenyl)methoxy group, (3,4,5-trimethylphenyl)methoxy group, (2,3,4,5-tetramethylphenyl)methoxy group, (2,3,4,6-tetramethylphenyl)methoxy group, (2,3,5,6-tetramethylphenyl)methoxy group, (pentamethylphenyl)methoxy group, (ethylphenyl)methoxy group, (n-propylphenyl)methoxy group, (isopropylphenyl)methoxy group, (n-butylphenyl)methoxy group, (sec-butylphenyl)methoxy group, (tert-butylphenyl) methoxy group, (n-hexylphenyl)methoxy group, (n-octylphenyl)methoxy group, (n-decylphenyl)methoxy group, naphthylmethoxy group, and anthracenylmethoxy group. Any of these aralkyloxy groups may be partly substituted with a halogen atom such as fluorine atom, chlorine atom, bromine atom and iodine atom; an alkoxyl group such as methoxy and ethoxy; an aryloxy group such as phenoxy or an aralkyloxy group such as benzyloxy.

The aryloxy groups include phenoxy group, 2-methylphenoxy group, 3-methylphenoxy group, 4-methylphenoxy group, 2,3-dimethylphenoxy group, 2,4-dimethylphenoxy group, 2,5-dimethylphenoxy group, 2,6-dimethylphenoxy group, 3,4-dimethylphenoxy group, 3,5-dimethylphenoxy group, 2-tert-butyl-3-methylphenoxy group, 2-tert-butyl-4-methylphenoxy group, 2-tert-butyl-5-methylphenoxy group, 2-tert-butyl-6-methylphenoxy group, 2,3,4-trimethylphenoxy group, 2,3,5-trimethylphenoxy group, 2,3,6-trimethylphenoxy group, 2,4,5-trimethylphenoxy group, 2,4,6-trimethylphenoxy group, 2-tert-butyl-3,4-dimethylphenoxy group, 2-tert-butyl-3,5-dimethylphenoxy group, 2-tert-butyl-3,6-dimethylphenoxy group, 2,6-di-tert-butyl-3-methylphenoxy group, 2-tert-butyl-4,5-dimethylphenoxy group, 2,6-di-tert-butyl-4-methylphenoxy group, 3,4,5-trimethylphenoxy group, 2,3,4,5-tetramethylphenoxy group, 2-tert-butyl-3,4,5-trimethylphenoxy group, 2,3,4,6-tetramethylphenoxy group, 2-tert-butyl-3,4,6-trimethylphenoxy group, 2,6-di-tert-butyl-3,4-dimethylphenoxy group, 2,3,5,6-tetramethylphenoxy group, 2-tert-butyl-3,5,6-trimethylphenoxy group, 2,6-di-tert-butyl-3,5-dimethylphenoxy group, pentamethylphenoxy group, ethylphenoxy group, n-propylphenoxy group, isopropylphenoxy group, n-butylphenoxy group, sec-butylphenoxy group, tert-butylphenoxy group, n-hexylphenoxy group, n-octylphenoxy group, n-decylphenoxy group, n-tetradecylphenoxy group, naphthoxy group, and anthracenoxy group. Any of these aryloxy groups may be partly substituted with a halogen atom such as fluorine atom, chlorine atom, bromine atom and iodine atom; an alkoxyl group such as methoxy and ethoxy; an aryloxy group such as phenoxy or an aralkyloxy group such as benzyloxy.

In the formulae [1] and [2], a is a number which satisfies the definition of 0<a≦8 and b is a number which satisfies the definition of 0<b≦8, both of which are properly selected in accordance with the valency of M¹. When M¹ is a titanium, zirconium or hafnium atom, a is preferably 2 and b is also preferably 2.

Examples of the metallocene-based compounds (B1) are bis(cyclopentadienyl)titanium dichloride, bis(methylcyclopentadieny)titanium dichloride, bis(ethylcyclopentadienyl)titanium dichloride, bis(n-butylcyclopentadienyl)titanium dichloride, bis(tert-butylcyclopentadienyl)titanium dichloride, bis(1,2-dimethylcyclopentadienyl)titanium dichloride, bis(1,3-dimethylcyclopentadienyl)titanium dichloride, bis(1-methyl-2-ethylcyclopentadienyl)titanium dichloride, bis(1-methyl-3-ethylcyclopentadienyl)titanium dichloride, bis(1-methyl-2-n-butylcyclopentadienyl)titanium dichloride, bis(1-methyl-3-n-butylcyclopentadienyl)titanium dichloride, bis(1-methyl-2-isopropylcyclopentadienyl)titanium dichloride, bis(1-methyl-3-isopropylcyclopentadienyl)titanium dichloride, bis(1-tert-butyl-2-methylcyclopentadienyl)titanium dichloride, bis(1-tert-butyl-3-methylcyclopentadienyl)titanium dichloride, bis(1,2,3-trimethylcyclopentadienyl)titanium dichloride, bis(1,2,4-trimethylcyclopentadienyl)titanium dichloride, bis(tetramethylcyclopentadienyl)titanium dichloride, bis(pentamethylcyclopentadienyl)titanium dichloride, bis(indenyl)titanium dichloride, bis(4,5,6,7-tetrahydroindenyl)titanium dichloride, bis(fluorenyl)titanium dichloride, bis(2-phenylindenyl)titanium dichloride,

bis[2-(bis-3,5-trifluoromethylphenyl)indenyl]titanium dichloride, bis[2-(4-tert-butylphenyl)indenyl]titanium dichloride, bis[2-(4-trifluoromethylphenyl)indenyl]titanium dichloride, bis[2-(4-methylphenyl)indenyl]titanium dichloride, bis[2-(3,5-dimethylphenyl)indenyl]titanium dichloride, bis[2-(pentafluorophenyl)indenyl]titanium dichloride, cyclopentadienyl(pentamethylcyclopentadienyl)titanium dichloride, cyclopentadienyl(indenyl)titanium dichloride, cyclopentadienyl(fluorenyl)titanium dichloride, indenyl(fluorenyl)titanium dichloride, pentamethylcyclopentadienyl(indenyl)titanium dichloride, pentamethylcyclopentadienyl(fluorenyl)titanium dichloride, cyclopentadienyl(2-phenylindenyl)titanium dichloride, pentamethylcyclopentadienyl(2-phenylindenyl)titanium dichloride,

dimethylsilylenebis(cyclopentadieny)titanium dichloride, dimethylsilylenebis(2-methylcyclopentadienyl)titanium dichloride, dimethylsilylenebis(3-methylcyclopentadienyl)titanium dichloride, dimethylsilylenebis(2-n-butylcyclopentadienyl)titanium dichloride, dimethylsilylenebis(3-n-butylcyclopentadienyl)titanium dichloride, dimethylsilylenebis(2,3-dimethylcyclopentadienyl)titanium dichloride, dimethylsilylenebis(2,4-dimethylcylopentadienyl)titanium dichloride, dimethylsilylenebis(2,5-dimethylcyclopentadienyl)titanium dichloride, dimethylsilylenebis(3,4-dimethylcyclopentadienyl)titanium dichloride, dimethylsilylenebis(2,3-ethylmethylcyclopentadienyl)titanium dichloride, dimethylsilylenebis(2,4-ethylmethylcyclopentadienyl)titanium dichloride, dimethylsilylenebis(2,5-ethylmethylcyclopentadienyl)titanium dichloride, dimethylsilylenebis(3,5-ethylmethylcyclopentadienyl)titanium dichloride, dimethylsilylenebis(2,3,4-trimethylcyclopentadienyl)titanium dichloride, dimethylsilylenebis(2,3,5-trimethylcyclopentadienyl)titanium dichloride, dimethylsilylenebis(tetramethylcyclopentadienyl)titanium dichloride,

dimethylsilylenebis(indenyl)titanium dichloride, dimethylsilylenebis(2-methylindenyl)titanium dichloride, dimethylsilylenebis(2-tert-butylindenyl)titanium dichloride, dimethylsilylenebis(2,3-dimethylindenyl)titanium dichloride, dimethylsilylenebis(2,3,7-trimethylindenyl)titanium dichloride, dimethylsilylenebis(2-methyl-4-isopropylindenyl)titanium dichloride, dimethylsilylenebis(4,5-benzindenyl)titanium dichloride, dimethylsilylenebis(2-methyl-4,5-benzindenyl)titanium dichloride, dimethylsilylenebis(2-phenylindenyl)titanium dichloride, dimethylsilylenebis(4-phenylindenyl)titanium dichloride, dimethylsilylenebis(2-methyl-4-phenylindenyl)titanium dichloride, dimethylsilylenebis(2-methyl-5-phenylindenyl)titanium dichloride, dimethylsilylenebis(2-methyl-4-naphthylindenyl)titanium dichloride, dimethylsilylenebis(4,5,6,7-tetrahydroindenyl)titanium dichloride,

dimethylsilylene(cyclopentadienyl)(indenyl)titanium dichloride, dimethylsilylene(methylcyclopentadienyl)(indenyl)titanium dichloride, dimethylsilylene(n-butylcyclopentadienyl)(indenyl)titanium dichloride, dimethylsilylene(tetramethylcyclopentadienyl)(indenyl)titanium dichloride, dimethylsilylene(cyclopentadienyl)(fluorenyl)titanium dichloride, dimethylsilylene(methylcyclopentadienyl)(fluorenyl)titanium dichloride, dimethysilylene(n-butylcyclopentadienyl)(fluorenyl)titanium dichloride, dimethyl-silylene(tetramethylcyclopentadienyl)(indenyl)titanium dichloride, dimethylsilylene(indenyl)(fluorenyl)titanium dichloride, dimethylsilylenebis(fluorenyl)titanium dichloride, dimethylsilylene(cyclopentadienyl)(tetra-methylcyclopentadienyl)titanium dichloride, dimethyl-silylene(tetramethylcyclopentadienyl)(fluorenyl)titanium dichloride,

cyclopentadienyltitanium trichloride, pentamethylcyclopentadienyltitanium trichloride, cyclopentadienyl(dimethylamido)titanium dichloride, cyclopentadienyl(phenoxy)titanium dichloride, cyclopentadienyl(2,6-dimethylphenyl)titanium dichloride, cyclopentadienyl(2,6-diisopropylphenyl)titanium dichloride, cyclopentadienyl(2,6-di-tert-butylphenyl)titanium dichloride, pentamethylcyclopentadienyl(2,6-dimethylphenyl)titanium dichloride, pentamethylcyclopentadienyl(2,6-diisopropylphenyl)titanium dichloride, pentamethylcyclopentadienyl(2,6-tert-butylphenyl)titanium dichloride, indenyl(2,6-diisopropylphenyl)titanium dichloride, fluorenyl(2,6-diisopropylphenyl)titanium dichloride,

dimethylsilylene(cyclopentadienyl)(2-phenoxy)titanium dichloride, dimethylsilylene(cyclopentadienyl)(3-methyl-2-phenoxy)titanium dichloride, dimethylsilylene(cyclopentadienyl)(3,5-dimethyl-2-phenoxy)titanium dichloride, dimethylsilylene(cyclopentadienyl)(3-tert-butyl-2-phenoxy)titanium dichloride, dimethylsilylene(cyclopentadienyl)(3-tert-5-methyl-2-phenoxy)titanium dichloride, dimethylsilylene(cyclopentadienyl)(3,5-di-tert-butyl-2-phenoxy)titanium dichloride, dimethylsilylene(cyclopentadienyl)(5-methyl-3-phenyl-2-phenoxy)titanium dichloride, dimethylsilylene(cyclopentadienyl)(3-tert-butyldimethylsilyl-5-methyl-2-phenoxy)titanium dichloride, dimethylsilylene(cyclopentadienyl)(5-methyl-3-trimethylsilyl-2-phenoxy)titanium dichloride, dimethylsilylene(cyclopentadienyl)(3-tert-butyl-5-methoxy-2-phenoxy)titanium dichloride, dimethylsilylene(cyclopentadienyl)(3-tert-butyl-5-chloro-2-phenoxy)titanium dichloride, dimethylsilylene(cyclopentadienyl)(3,5-diamyl-2-phenoxy)titanium dichloride, dimethylsilylene(cyclopentadienyl)(3-phenyl-2-phenoxy)titanium dichloride, dimethylsilylene(cyclopentadienyl)(1-naphthoxy-2-yl)titanium dichloride

dimethylsilylene(methylcyclopentadienyl)(2-phenoxy)titanium dichloride, dimethyllsilylene(methylcyclopentadienyl)(3-methyl-2-phenoxy)titanium dichloride, dimethylsilylene(methylcyclopentadienyl)(3,5-dimethyl-2-phenoxy)titanium dichloride, dimethylsilylene(methylcyclopentadienyl)(3-tert-butyl-2-phenoxy)titanium dichloride, dimethylsilylene(methylcyclopentadienyl)(3-tert-butyl-5-methyl-2-phenoxy)titanium dichloride, dimethylsilylene(methylcyclopentadienyl)(3,5-di-tert-butyl-2-phenoxy)titanium dichloride, dimethylsilylene(methylcyclopentadienyl)(5-methyl-3-phenyl-2-phenoxy)titanium dichloride, dimethylsilylene(methylcyclopentadienyl)(3-tert-butyldimethylsilyl-5-methyl-2-phenoxy)titanium dichloride, dimethylsilylene(methylcyclopentadienyl)(5-methyl-3-trimethylsilyl-2-phenoxy)titanium dichloride, dimethylsilylene(methylcyclopentadienyl)(3-tert-butyl-5-methoxy-2-phenoxy)titanium dichloride, dimethylsilylene(methylcyclopentadienyl)(3-tert-butyl-5-chloro-2-phenoxy)titanium dichloride, dimethylsilylene(methylcyclopentadienyl)(3,5-diamyl-2-phenoxy)titanium dichloride, dimethylsilylene(methylcyclopentadienyl)(3-phenyl-2-phenoxy)titanium dichloride, dimethylsilylene(methylcyclopentadienyl)(1-naphthoxy-2-yl)titanium dichloride,

dimethylsilylene(n-butylcyclopentadienyl)(2-phenoxy)titanium dichloride, dimethylsilylene(n-butylcyclopentadienyl)(3-methyl-2-phenoxy)titanium dichloride, dimethylsilylene(n-butylcyclopentadienyl)(3,5-dimethyl-2-phenoxy)titanium dichloride, dimethylsilylene(n-butylcyclopentadienyl)(3-tert-butyl-2-phenoxy)titanium dichloride, dimethylsilylene(n-butylcyclopentadienyl)(3-tert-butyl-5-methyl-2-phenoxy)titanium dichloride, dimethylsilylene(n-butylcyclopentadienyl)(3,5-di-tert-butyl-2-phenoxy)titanium dichloride, dimethylsilylene(n-butylcyclopentadienyl)(5-methyl-3-phenyl-2-phenoxy)titanium dichloride, dimethylsilylene(n-butylcyclopentadienyl)(3-tert-butyldimethylsilyl-5-methyl-2-phenoxy)titanium dichloride, dimethylsilylene(n-butylcyclopentadienyl)(5-methyl-3-trimethylsilyl-2-phenoxy)titanium dichloride, dimethylsilylene(n-butylcyclopentadienyl)(3-tert-butyl-5-methoxy-2-phenoxy)titanium dichloride, dimethylsilylene(n-butylcyclopentadienyl)(3-tert-butyl-5-chloro-2-phenoxy)titanium dichloride, dimethylsilylene(n-butylcyclopentadienyl)(3,5-diamyl-2-phenoxy)titanium dichloride, dimethylsilylene(n-butylcyclopentadienyl)(3-phenyl-2-phenoxy)titanium dichloride, dimethylsilylene(n-butylcyclopentadienyl)(1-naphthoxy-2-yl)titanium dichloride,

dimethylsilylene(tert-butylcyclopentadienyl)(2-phenoxy)titanium dichloride, dimethylsilylene(tert-butylcyclopentadienyl)(3-methyl-2-phenoxy)titanium dichloride, dimethylsilylene(tert-butylcyclopentadienyl)(3,5-dimethyl-2-phenoxy)titanium dichloride, dimethylsilylene(tert-butylcyclopentadienyl)(3-tert-butyl-2-phenoxy)titanium dichloride, dimethylsilylene(tert-butylcyclopentadienyl)(3-tert-butyl-5-methyl-2-phenoxy)titanium dichloride, dimethylsilylene(tert-butylcyclopentadienyl)(3,5-di-tert-butyl-2-phenoxy)titanium dichloride, dimethylsilylene(tert-butylcyclopentadienyl)(5-methyl-3-phenyl-2-phenoxy)titanium dichloride, dimethylsilylene(tert-butylcyclopentadienyl)(3-tert-butyldimethylsilyl-5-methyl-2-phenoxy)titaniumdichloride, dimethylsilylene(tert-butylcyclopentadienyl)(5-methyl-3-trimethylsilyl-2-phenoxy)titanium dichloride, dimethylsilylene(tert-butylcyclopentadienyl)(3-tert-butyl-5-methoxy-2-phenoxy)titanium dichloride, dimethylsilylene(tert-butylcyclopentadienyl)(3-tert-butyl-5-chloro-2-phenoxy)titanium dichloride, dimethylsilylene(tert-butylcyclopentadienyl)(3,5-diamyl-2-phenoxy)titanium dichloride, dimethylsilylene(tert-butylcyclopentadienyl)(3-phenyl-2-phenoxy)titanium dichloride, dimethylsilylene(tert-butylcyclopentadienyl)(1-naphthoxy-2-yl)titanium dichloride,

dimethylsilylene(tetramethylcyclopentadienyl)(2-phenoxy)titanium dichloride, dimethylsilylene(tetramethylcyclopentadienyl)(3-methyl-2-phenoxy)titanium dichloride, dimethylsilylene(tetramethylcyclopentadienyl)(3,5-dimethyl-2-phenoxy)titanium dichloride, dimethylsilylene(tetramethylcyclopentadienyl)(3-tert-butyl-2-phenoxy)titanium dichloride, dimethylsilylene(tetramethylcyclopentadienyl)(3-tert-butyl-5-methyl-2-phenoxy)titanium dichloride, dimethylsilylene(tetramethylcyclopentadienyl)(3,5-di-tert-butyl-2-phenoxy)titanium dichloride, dimethylsilylene(tetramethylcyclopentadienyl)(5-methyl-3-phenyl-2-phenoxy)titanium dichloride, dimethylsilylene(tetramethylcyclopentadienyl)(3-tert-butyldimethylsilyl-5-methyl-2-phenoxy)titanium dichloride, dimethylsilylene(tetramethylcyclopentadienyl)(5-methyl-3-trimethylsilyl-2-phenoxy)titanium dichloride, dimethylsilylene(tetramethylcyclopentadienyl)(3-tert-butyl-5-methoxy-2-phenoxy)titanium dichloride, dimethylsilylene(tetramethylcyclopentadienyl)(3-tert-butyl-5-chloro-2-phenoxy)titanium dichloride, dimethylsilylene(tetramethylcyclopentadienyl)(3,5-diamyl-2-phenoxy)titanium dichloride, dimethylsilylene(tetramethylcyclopentadienyl)(3-phenyl-2-phenoxy)titanium dichloride, dimethylsilylene(tetramethylcyclopentadienyl)(1-naphthoxy-2-yl)titanium dichloride,

dimethylsilylene(trimethylsilylcyclopentadienyl)(2-phenoxy)titanium dichloride, dimethylsilylene(trimethylsilylcyclopentadienyl)(3-methyl-2-phenoxy)titanium dichloride, dimethylsilyene)trimethylsilylcyclopentadienyl)(3,5-dimethyl-2-phenoxy)titanium dichloride, dimethylsilylene(trimethylsilylcyclopentadienyl)(3-tert-butyl-2-phenoxy)titanium dichloride, dimethylsilylene(trimethylsilylcyclopentadienyl)(3-tert-butyl-5-methyl-2-phenoxy)titanium dichloride, dimethylsilylene(trimethylsilylcyclopentadienyl)(3,5-di-tert-butyl-2-phenoxy)titanium dichloride, dimethylsilylene(trimethylsilylcyclopentadienyl)(5-methyl-3-phenyl-2-phenoxy)titanium dichloride, dimethylsilylene(trimethylsilylcyclopentadienyl)(3-tert-butyldimethylsilyl-5-methyl-2-phenoxy)titanium dichloride, dimethylsilylene(trimethylsilylcyclopentadienyl)(5-methyl-3-trimethylsilyl-2-phenoxy)titanium dichloride, dimethylsilylene(trimethylsilylcyclopentadienyl)(3-tert-butyl-5-methoxy-2-phenoxy)titanium dichloride, dimethylsilylene(trimethylsilylcyclopentadienyl)(3-tert-butyl-5-chloro-2-phenoxy)titanium dichloride, dimethylsilylene(trimethylsilylcyclopentadienyl)(3,5-diamyl-2-phenoxy)titanium dichloride, dimethylsilylene(trimethylsilylcyclopentadienyl)(3-phenyl-2-phenoxy)titanium dichloride, dimethylsilylene(trimethylsilylcyclopentadienyl)(1-naphthoxy-2-yl)titanium dichloride,

dimethylsilylene(indenyl)(2-phenoxy)titanium dichloride, dimethylsilylene(indenyl)(3-methyl-2-phenoxy)titanium dichloride, dimethylsilylene(indenyl)(3,5-dimethyl-2-phenoxy)titanium dichloride, dimethylsilylene(indenyl)(3-tert-butyl-2-phenoxy)titanium dichloride, dimethylsilylene(indenyl)(3-tert-butyl-5-methyl-2-phenoxy)titanium dichloride, dimethylsilylene(indenyl)(3,5-di-tert-butyl-2-phenoxy)titanium dichloride, dimethylsilylene(indenyl)(5-methyl-3-phenyl-2-phenoxy)titanium dichloride, dimethylsilylene(indenyl)(3-tert-butyldimethylsilyl-5-methyl-2-phenoxy)titanium dichloride dimethylsilylene(indenyl)(5-methyl-3-trimethylsilyl-2-phenoxy)titanium dichloride, dimethylsilylene(indenyl)(3-tert-butyl-5-methoxy-2-phenoxy)titanium dichloride, dimethylsilylene(indenyl)(3-tert-butyl-5-chloro-2-phenoxy)titanium dichloride, dimethylsilylene(indenyl)(3,5-diamyl-2-phenoxy)titanium dichloride, dimethylsilylene(indenyl)(3-phenyl-2-phenoxy)titanium dichloride, dimethylsilylene(indenyl)(1-naphthoxy-2-yl)titanium dichloride,

dimethylsilylene(fluorenyl)(2-phenoxy)titanium dichloride, dimethylsilylene(fluorenyl)(3-methyl-2-phenoxy)titanium dichloride, dimethylsilylene(fluorenyl)(3,5-dimethyl-2-phenoxy)titanium dichloride, dimethylsilylene(fluorenyl)(3-tert-butyl-2-phenoxy)titanium dichloride, dimethylsilylene(fluorenyl)(3-tert-butyl-5-methyl-2-phenoxy)titanium dichloride, dimethylsilylene(fluorenyl)(3,5-di-tert-butyl-2-phenoxy)titanium dichloride, dimethylsilylene(fluorenyl)(5-methyl-3-phenyl-2-phenoxy)titanium dichloride, dimethylsilylene(fluorenyl)(3-tert-butyldimethylsilyl-5-methyl-2-phenoxy)titanium dichloride, dimethylsilylene(fluorenyl)(5-methyl-3-trimethylsilyl-2-phenoxy)titanium dichloride, dimethylsilylene(fluorenyl)(3-tert-butyl-5-methoxy-2-phenoxy)titanium dichloride, dimethylsilylene(florenyl)(3-tert-butyl-5-chloro-2-phenoxy)titanium dichloride, dimethylsilylene(fluorenyl)(3,5-diamyl-2-phenoxy)titanium dichloride, dimethylsilylene(fluorenyl)(3-phenyl-2-phenoxy)titanium dichloride, dimethylsilylene(fluorenyl)(1-naphthoxy-2-yl)titanium dichloride,

(tert-butylamido)tetramethylcyclopentadienyl-1,2-ethanediyltitanium dichloride, (methylamido)tetramethylcyclopentadienyl-1,2-ethanediyltitanium dichloride, (ethylamido)tetramethylcyclopentadienyl-1,2-ethanediyltitanium dichloride, (tert-butylamido)tetramethylcyclopentadienyldimethylsilanetitanium dichloride, (benzylamido) tetramethylcyclopentadienyldimethylsilanetitanium dichloride, (phenylphosphide)tetramethylcyclopentadienyldimethylsilanetitanium dichloride, (tert-butylamido)indenyl-1,2-ethanediyltitanium dichloride,(tert-butylamido)tetrahydroindenyl-1,2-ethanediyltitanium dichloride, (tert-butylamido)fluorenyl-1,2-ethanediyltitanium dichloride, (tert-butylamido) indenyldimethylsilanetitanium dichloride, (tert-butylamido)tetrahydroindenyldimethylsilanetitanium dichloride, (tert-butylamido) fluorenyldimethylsilanetitanium dichloride.

(dimethylaminomethyl)tetramethylcyclopentadienyl (III) dichloride, (dimethylaminoethyl)tetramethylcyclopentadienyltitanium (III) dichloride, (dimethylaminopropyl)tetramethylcyclopentadienyltitanium (III) dichloride, (N-pyrrolidinylethyl)tetramethylcyclopentadienyltitanium dichloride, (B-dimethylaminoborabenzene)cyclopentadienyltitanium dichloride, cyclopentadienyl(9-mesitylboraanthracenyl)titanium dichloride, and those of the above compounds in which titanium has been converted to zirconium or hafnium, (2-phenoxy) has been converted to (3-phenyl-2-phenoxy), (3-trimethylsilyl-2-phenoxy) or (3-tert-butyldimethylsilyl-2-phenoxy), dimethylsilylene has been converted to methylene, ethylene, dimethylmethylene(isopropylidene), diphenylmethylene, diethylsilylene, diphenylsilylene or dimethoxysilylene, dichloride has been converted to difluoride, dibromide or diiodide, or trichloride has been converted to trifluoride, tribromide or triiodide.

Examples of the metallocene-based compounds (B2) include those of the above-shown metallocene-based compounds (B1) in which dichloride has been converted to dimethyl, diethyl, diisopropyl, diphenyl, dibenzyl, dimethoxide, diethoxide, di(n-propoxide), di(isopropoxide), diphenoxide or (pentafluorophenoxide), or trichloride has been converted to trimethyl, triethyl, triisopropyl, triphenyl, tribenzyl, trimethoxide, triethoxide, tri(n-propoxide), tri(isopropoxide), triphenoxide or tri(pentafluorophenoxide). They also include those of the above-shown metallocene-based compounds (B1) in which, as in the case of the metallocene-based compounds (B1), titanium has been converted to zirconium or hafnium, (2-phenoxy) has been converted to (3-phenyl-2-phenoxy), (3-trimethylsilyl-2-phenoxy) or (3-tert-butyldimethylsilyl-2-phenoxy), or dimethylsilylene has been converted to methylene, ethylene, dimethylmethylene (isopropylidene), diphenylmethylene, diethylsilylene, diphenylsilylene or dimethoxysilylene.

Also, in the metallocene-based compounds (B1), examples of the μ-oxo type of the transition metal compounds represented by the formula [1] include μ-oxobis[isopropylidene(cyclopentadienyl)(2-phenoxy)titanium chloride], μ-oxobis[isopropylidene(cyclopentadienyl)(3-tert-butyl-5-methyl-2-phenoxy)titanium chloride], μ-oxobis[isopropylidene(methylcyclopentadienyl)(2-phenoxy)titanium chloride], μ-oxobis[isopropylidene(methylcyclopentadienyl)(3-tert-butyl-5-methyl-2-phenoxy)titanium chloride], μ-oxobis[isopropylidene(tetramethylcyclopentadienyl)(2-phenoxy)titanium chloride, μ-oxobis[isopropylidene(tetramethylcyclopentadienyl)(3-tert-butyl-5-methyl-2-phenoxy)titanium chloride], μ-oxobis[dimethylsilylene(cyclopentadienyl)(2-phenoxy)titanium chloride], μ-oxobis[dimethylsilylene(cyclopentadienyl)(3-tert-butyl-5-methyl-2-phenoxy)titanium chloride], μ-oxobis[dimethylsilylene(methylcyclopentadienyl)(2-phenoxy)titanium chloride], μ-oxobis[dimethylsilylene(methylcyclopentadienyl)(3-tert-butyl-5-methyl-2-phenoxy)titanium chloride], μ-oxobis[dimethylsilylene(tetramethylcyclopentadienyl)(2-phenoxy)titanium chloride], μ-oxobis[dimethylsilylene(tetramethylcyclopentadienyl)(3-tert-butyl-5-methyl-2-phenoxy)titanium chloride], and those of the above-shown compounds in which titanium has been converted to zirconium or hafnium, or chloride has been converted to fluoride, bromide or iodide.

Diphenylmethylene(cyclopentadienyl)(9-fluorenyl)zirconium dichloride is preferably used as metallocene-based compound (B1).

In the metallocene-based compounds (B2), examples of the μ-oxo type of the transition metal compounds represented by the formula [2] include those of the metallocene-based compounds (B1) in which chloride has been converted to methyl, ethyl, isopropyl, phenyl, benzyl, methoxide, ethoxide, n-propoxide, isoproxide, phenoxide or pentafluorophenoxide. They also include those of the above-shown metallocene-based compounds (B1) in which, as in the case of the metallocene-based compounds (B1), titanium has been converted to zirconium or hafnium.

Racemic-ethylenebis(1-indenyl)zirconium diphenoxide is preferably used as metallocene-based compound (B2).

Examples of the organoaluminum compounds (C) include trialkylaluminums such as trimethylaluminum, triethylaluminum, tri-n-butylaluminum, triisobutylaluminum, tri-n-hexylaluminum and tri-n-octylaluminum; dialkylaluminum hydrides such as diethylaluminum hydride and diisobutylalunium hydride; and dialkylaluminum hydrides such as diethylaluminum chloride and diisobutylaluminum chloride. Of these compounds, triisobutylaluminum and normal trioctylaluminum are preferred.

The prepolymerization catalyst component obtained according to the present invention is usable as a component of a polymerization catalyst used for the production of olefin polymers. Examples of the olefins usable for the olefin polymerization include chainlike olefins such as ethylene, propylene, 1-butene, 1-pentene, 4-methyl-1-pentene, 5-methyl-1-hexene, 1-hexene, 1-heptene, 1-octene, 1-nonene and 1-decene; cyclic olefins such as norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacylohexadecene, 8-methyltetracyclodecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, and 8-cyanotetracyclododecene; and diolefins such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadiene, 1,3-octadiene, 1,3-cyclooctadiene, and 1,3-cyclohexadiene. These olefins may be used alone or as a combination of any two or more of them. Preferably, a combination of ethylene and an olefin other than ethylene, more preferably ethylene alone or a combination of ethylene and an α-olefin, even more preferably ethylene alone or a combination of ethylene and at least one α-olefin selected from 1-butene, 1-hexene and 1-octene is used.

As the olefin polymerization method, slurry polymerization or vapor phase polymerization is preferably used. Plural sets of reactor may be used in the production method of the present invention.

Vapor phase polymerization of olefins is carried out at a temperature of usually from 30 to 110° C., preferably from 60 to 100° C., under a pressure of usually from 0.1 to 5.0 MPa, preferably from 1.5 to 3.0 PMa. In the case of slurry polymerization, the temperature may usually range from −30 to +150° C., but a temperature range of from 0 to 100° C. is preferred, and a range of from 0 to 80° C. is more preferred for strengthening activity of the prepolymerization catalyst component.

Olefin polymerization is carried out using, in addition to the above-described prepolymerization catalyst component of the present invention, other catalyst component(s) such as an organoaluminum compound, organoaluminoxy compound, boron compound and the like according to the type of the prepolymerization catalyst component used. Also, the polymerization may be conducted in the presence of a chain transfer agent such as hydrogen and other additives.

### EXAMPLES

The present invention will be described in further detail below with reference to the examples and comparative examples.

### Example 1

### (1) Preparation of Cocatalyst Support

2.8 kg of silica (Sylopol 948 produced by Davison Co. Ltd.; 50% volume-average particle diameter=55 μm; pore volume=1.67 ml/g; specific surface area=325 m²/g), which had been heat treated at 300° C. in a stream of nitrogen, and 24 kg of toluene were supplied to a nitrogen-replaced reactor equipped with a stirrer and stirred. After the mixture has been cooled to 5° C., a mixed solution of 0.9 kg of 1,1,1,3,3,3-hexamethyldisilazane and 1.4 kg of toluene was added dropwise over a period of 30 minutes while maintaining the reactor temperature at 5° C. After the end of the dropwise addition, the resultant solution was stirred at 5° C. for one hour, then heated to 95° C., again stirred at 95° C. for 3 hours, and filtered. The obtained solid product was washed 6 times with 20.8 kg of toluene. Then 7.1 kg of toluene was added to form a slurry, which was allowed to stand overnight.

To the thus obtained slurry, 1.73 kg of a hexane solution of diethylzinc (diethylzinc concentration: 50% by weight) and 1.02 kg of hexane were supplied followed by stirring. After the mixture has been cooled to 5° C., a mixed solution of 0.78 kg of 3,4,5-trifluorophenol and 1.44 kg of toluene was added dropwise over a period of 60 minutes while maintaining the reactor temperature at 5° C. After the end of the dropwise addition, the mixture was stirred at 5° C. for one hour, then heated to 40° C. and stirred at 40° C. for one hour. Then the mixture was cooled to 22° C., and 0.11 kg of H₂O was added dropwise over a period of 1.5 hours while maintaining the reactor temperature at 22° C. After the end of the dropwise addition, the mixture was stirred at 22° C. for 1.5 hours, then heated to 40° C., further stirred at 40° C. for 2 hours, then heated to 80° C., and stirred at 80° C. for 2 hours. After stirring, the supernatant solution was pipetted out at room temperature until the residual amount became 16 litres, after which 11.6 kg of toluene was supplied and the mixture was heated to 95° C. and stirred for 4 hours. After stirring, the supernatant solution was pipetted out at room temperature to obtain a solid product. This solid product was washed four times with 20.8 kg of toluene and 3 times with 24 litres of hexane and then dried to obtain a cocatalyst support (a).

### (2) Preparation of Prepolymerization Catalyst Component

836 g of normal butane was supplied to a nitrogen-replaced 5-litre autoclave equipped with a stirrer. The autoclave was heated to 50° C., to which 9.2 mg (0.017 mmol) of red powdery diphenylmethylene(cyclopentadienyl)(9-flourenyl)zirconium dichloride was fed in a powdery form, and the mixture was stirred at 50° C. for one hour. Then 0.71 g (1.3 mmol) of orange-colored powdery racemic-ethylenebis(1-indenyl)zirconium diphenoxide was supplied in a powdery form ((B2)/(B1)=76), and the mixture was stirred at 50° C. for one hour. Then 28 g of ethylene was supplied, and after the system has been stabilized, 10.6 g of the above-described cocatalyst support (a) was supplied, followed by the supply of 4.1 mmol of triisobutylaluminum to commence the polymerization. 110-minute prepolymerization was carried out at 50° C. while continuously feeding an ethylene-hydrogen mixed gas with a hydrogen concentration of 0.2%. After the end of the polymerization, ethylene, normal butane and hydrogen were purged and the residual solid was dried at room temperature to obtain a light-yellow prepolymerization catalyst component containing 16.2 g of polyethylene per gram of the cocatalyst support (a). The obtained prepolymerization catalyst component was homogeneous and free of aggregates of granules. Also, there was seen no deposition of the prepolymerization catalyst component and the polymer on the inner wall of the autoclave after recovery of the prepolymerization catalyst component.

### Example 2

### (1) Preparation of Prepolymerization Catalyst Component

835 g of normal butane was supplied to a nitrogen-replaced 5-litre autoclave, and the autoclave was heated to 50° C. Then 4.8 mg (0.0086 mmol) of red powdery diphenylmethylene(cyclopentadienyl)(9-fluorenyl)zirconium dichloride was supplied in a form of powder, followed by one-hour stirring at 50° C., after which 0.75 g (1.4 mmol) of orange-colored powdery racemic-ethylenebis(1-indenyl)zirconium diphenoxide was supplied in a form of powder ((B2)/(B1)=163), and the mixture was stirred at 50° C. for one hour. Then 28 g of ethylene was supplied, and after the system has been stabilized, 10.4 g of the above-described cocatalyst support (a) was introduced into the system, followed by supply of 4.2 mmol of triisobutylaluminum to start the polymerization. 100-minute prepolymerization was carried out at 50° C. while continuously feeding an ethylene-hydrogen mixed gas with a hydrogen concentration of 0.2%. After the end of the polymerization, ethylene, normal butane and hydrogen were purged and the residual solid was dried at room temperature to obtain a light-yellow prepolymerization catalyst component containing 16.3 g of polyethylene per gram of the cocatalyst support (a). The obtained prepolymerization catalyst component was homogeneous and free of aggregates of granules. Also, there was seen no deposition of the prepolymerization catalyst component and the polymer on the inner wall of the autoclave after recovery of the prepolymerization catalyst component.

### Comparative Example 1

### (1) Preparation of Prepolymerization Catalyst Component

835 g of normal butane was supplied to a nitrogen-replaced 5-litre autoclave equipped with a stirrer, and the autoclave was heated to 50° C. Then 9.8 mg (0.018 mmol) of red powdery diphenylmethylene(cyclopentadienyl)(9-fluorenyl)zirconium dichloride and 0.73 g (1.4 mmol) of orange-colored powdery racemic-ethylenebis(1-indenyl)zirconium diphenoxide were supplied simultaneously in a powdery form ((B2)/(B1)=78), and the mixture was stirred at 50° C. for 2 hours. Then 28 g of ethylene was supplied, and after the system has been stabilized, 10.7 g of the above-described cocatalyst support (a) was fed, followed by supply of 4.2 mmol of triisobutylaluminum to start polymerization. 100-minute prepolymerization was carried out at 50° C. while continuously feeding an ethylene-hydrogen mixed gas with a hydrogen concentration of 0.2%. After the end of the polymerization, ethylene, normal butane and hydrogen were purged and the residual solid was dried at room temperature to obtain a light-yellow prepolymerization catalyst component containing 18.1 g of polyethylene per gram of the cocatalyst support (a). Although the obtained prepolymerization catalyst component was free of aggregates or agglomerates of granules, the product had red spots and was heterogeneous. Also, there was seen slight deposition of the polymer on the inner wall of the autoclave after recovery of the prepolymerization catalyst component.

### Comparative Example 2

### (1) Preparation of Prepolymerization Catalyst Component

834 g of normal butane was supplied to a nitrogen-replaced 5-litre autoclave equipped with a stirrer, and the autoclave was heated to 50° C. Then a toluene solution of diphenylmethylene(cyclopentadienyl)(9-fluorenyl)zirconium dichloride, prepared by dissolving 10.1 mg (0.018 mmol) of this red powdery compound in 6 ml of toluene, was supplied and the mixture was stirred at 50° C. for 10 minutes. Then 0.72 g (1.3 mmol) of orange-colored powdery racemic-ethylenebis(1-indenyl)zirconium diphenoxide was supplied in a powdery form ((B2)/(B1)=72), and the mixture was stirred at 50° C. for 75 hours. Then 28 g of ethylene was supplied, and after the system has been stabilized, 10.6 g of the above-described cocatalyst support (a) was fed, followed by supply of 4.1 mmol of triisobutylaluminum to start polymerization. 110-minute prepolymerization was carried out at 50° C. while continuously feeding an ethylene-hydrogen mixed gas with a hydrogen concentration of 0.2%. After the end of the polymerization, ethylene, normal butane and hydrogen were purged and the residual solid was dried at room temperature to obtain a light-yellow prepolymerization catalyst component containing 17.5 g of polyethylene per gram of the cocatalyst support (a). The obtained prepolymerization catalyst component had many aggregates of granules. Also, there was seen deposition of 0.5 g of the polymer on the inner wall of the autoclave after recovery of the prepolymerization catalyst component.

### Comparative Example 3

### (1) Preparation of Prepolymerization Catalyst Component

834 g of normal butane was supplied to a nitrogen-replaced 5-litre autoclave equipped with a stirrer, and the autoclave was heated to 50° C. Then 2.3 ml (0.0069 mmol) of a toluene solution of diphenylmethylene(cyclopentadienyl)(9-fluorenyl)zirconium dichloride with its concentration of 3 μmmol was supplied and the mixture was stirred at 50° C. for 10 minutes. Then 0.72 g (1.3 mmol) of orange-colored powdery racemic-ethylenebis(1-indenyl)zirconium diphenoxide was supplied in a powdery form ((B2)/(B1)=188), and the mixture was stirred at 50° C. for 75 hours. Then 28 g of ethylene was supplied, and after the system has been stabilized, 10.5 g of the above-described cocatalyst support (a) was fed, followed by supply of 4.1 mmol of triisobutylaluminum to start polymerization. 110-minute prepolymerization was carried out at 50° C. while continuously feeding an ethylene-hydrogen mixed gas with a hydrogen concentration of 0.2%. After the end of the polymerization, ethylene, normal butane and hydrogen were purged and the residual solid was dried at room temperature to obtain a light-yellow prepolymerization catalyst component containing 15.2 g of polyethylene per gram of the cocatalyst support (a). The obtained prepolymerization catalyst component had many aggregates of granules. Also, there was seen deposition of 1.6 g of the polymer on the inner wall of the autoclave after recovery of the prepolymerization catalyst component.

1. A process for producing a prepolymerization catalyst component by carrying out a prepolymerization of an olefin in the presence of a contact treatment product (4) obtained by subjecting a cocatalyst support (A), a metallocene-based compound (B1), a metallocene-based compound (B2) and an organoaluminum compound (C) to a contact treatment, the process comprising the following steps (1) to (4):
step (1): heat-treating a solution containing a metallocene-based compound (B1), which is prepared by dissolving the metallocene-based compound (B1) shown below in a saturated hydrocarbon solvent, at 40° C. or above to obtain a heat-treated material (1);
step (2): heat-treating a mixture of the heat-treated material (1) and a metallocene-based compound (B2) shown below at 40° C. or above to obtain a heat-treated material (2);
step (3): subjecting the above heat-treated material (2) and a cocatalyst support (A) to a contact treatment to obtain a contact treatment product (3); and
step(4): subjecting the contact treatment product (3) and an organoaluminum compound (C) to a contact treatment to obtain a contact treatment product (4);
wherein the metallocene-based compound (B1) is a transition metal compound represented by the following formula [1] or its μ-oxo type transition metal compound dimer:
L¹ₐM¹X¹_{b} [1]
(wherein M¹ is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X¹ is a halogen atom; a is a number which satisfies the definition of 0<a≦8; and b is a number which satisfies the definition of 0<b≦8); and
the metallocene-based compound (B2) is a transition metal compound represented by the following formula [2] or its μ-oxo type transition metal compound dimer:
L¹ₐM¹X²_{b} [2]
(wherein M¹ is a periodic table Group 3 to 11 or lanthanoid series transition metal atom; each of L¹ is a group having a cyclopentadiene type anionic skeleton, and plural L¹ can be connected directly to each other or can be connected via a crosslinking group containing one or two or more of carbon atom, silicon atom, nitrogen atom, oxygen atom, sulfur atom or phosphorus atom; X² is a hydrocarbon group (exclusive of the groups having a cyclopentadiene type anionic skeleton) or a hydrocarbonoxy group; a is a number which satisfies the definition of 0<a≦8; and b is a number which satisfies the definition of 0<b≦8).

2. The process according to claim 1 wherein the temperature, at which the contact treatment product (3) and the organoaluminum compound (C) are brought into contact with each other in the step (4), is 70° C. or below.

3. The process according to claim 1 wherein the step (4) is carried out in the presence of an olefin.

4. A prepolymerization catalyst component produced by the process according to claim 3.

5. A process for producing an olefin polymer which comprises carrying out polymerization of an olefin by using the prepolymerization catalyst component according to claim 4.

6. A prepolymerization catalyst component produced by the process according to claim 2.

7. A process for producing an olefin polymer which comprises carrying out polymerization of an olefin by using the prepolymerization catalyst component according to claim 6.

8. The process according to claim 1 wherein the step (4) is carried out in the presence of an olefin.

9. A prepolymerization catalyst component produced by the process according to claim 8.

10. A process for producing an olefin polymer which comprises carrying out polymerization of an olefin by using the prepolymerization catalyst component according to claim 9.

11. A prepolymerization catalyst component produced by the process according to claim 1.

12. A process for producing an olefin polymer which comprises carrying out polymerization of an olefin by using the prepolymerization catalyst component according to claim 11.
